(19) United States
(12) Patent Application Publication
(10) Pub. No.: US 2016/0042548 A1
(43) Pub. Date: Feb. 11, 2016

(54) FACIAL EXPRESSION AND/OR INTERACTION DRIVEN AVATAR APPARATUS AND METHOD

(71) Applicant: INTEL CORPORATION, Santa Clara, CA (US)

(72) Inventors: Yangzhou DU, Beijing (CN); Tae-Hoon KIM, Seoul (KR); Wenlong LI, Beijing (CN); Qiang LI, Beijing (CN); Xiaofeng TONG, Beijing (CN); Tao WANG, Beijing (CN); Minje PARK, Seongnam (KR); Olivier DUCHENNE, Seoul (KR); Yimin ZHANG, Beijin (CN); Yeongjae CHEON, Seoul (KR); Bongjin JUN, Seoul (KR); Wooju RYU, Gyeonggi-do (KR); Thomas SACHSON, Menlo Park, CA (US); Mary D. SMILEY, Santa Clara, CA (US)

(21) Appl. No.: 14/416,580

(22) PCT Filed: Mar. 19, 2014
(86) PCT No.: PCT/CN2014/073695

§ 371 Date: Jan. 22, 2015

(51) Int. Cl. G06T 13/40; G06T 7/20; G06T 15/00; G06K 9/00

(52) U.S. Cl. CPC G06T 13/40; G06K 9/00315; G06T 7/2046; G06T 15/005; G06T 2207/10016; G06T 2207/30201; G06T 2200/04

(57) ABSTRACT

Apparatuses, methods and storage medium associated with animating and rendering an avatar are disclosed herein. In embodiments, an apparatus may include a facial mesh tracker to receive a plurality of image frames, detect facial action movements of a face and head pose gestures of a head within the plurality of image frames, and output a plurality of facial motion parameters and head pose parameters that depict facial action movements and head pose gestures detected, all in real time, for animation and rendering of an avatar. The facial action movements and head pose gestures may be detected through inter-frame differences for a mouth and an eye, or the head, based on pixel sampling of the image frames. The facial action movements may include opening or closing of a mouth, and blinking of an eye. The head pose gestures may include head rotation such as pitch, yaw, roll, and head movement along horizontal and vertical direction, and the head comes closer or goes farther from the camera. Other embodiments may be described and/or claimed.

### TECHNICAL FIELD

The present disclosure relates to the field of data processing. More particularly, the present disclosure relates to facial expression and/or interaction driven animation and rendering of avatar.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

As user's graphic representation, avatar has been quite popular in virtual world. However, most existing avatar systems are static, and few of them are driven by text, script or voice. Some other avatar systems use graphics interchange format (GIF) animation, which is a set of predefined static avatar image playing in sequence. In recent years, with the advancement of computer vision, camera, image processing, etc., some avatar may be driven by facial performance. However, existing systems tend to be computation intensive, requiring high-performance general and graphics processor, and do not work well on mobile devices, such as smartphones or computing tablets.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a block diagram of a pocket avatar system, according to the disclosed embodiments.

FIG. 2 illustrates a block diagram for the facial mesh tracker of FIG. 1 in further detail, according to the disclosed embodiments.

FIGS. 3 and 4 illustrate interaction driven avatar, according to the disclosed embodiments.

FIG. 5 is a flow diagram illustrating a process for generating facial expression and interaction animation messages, according to the disclosed embodiments.

FIG. 6 is a flow diagram illustrating a process for interleaving facial expression and interaction animations, according to the disclosed embodiments.

FIG. 7 is a flow diagram illustrating a process for estimating head pose, according to the disclosed embodiments.

FIG. 8 illustrates an example computer system suitable for use to practice various aspects of the present disclosure, according to the disclosed embodiments.

FIG. 9 illustrates a storage medium having instructions for practicing methods described with references to FIGS. 2-7, according to disclosed embodiments.

### DETAILED DESCRIPTION

Apparatuses, methods and storage medium associated with animating and rendering an avatar are disclosed herein. In embodiments, an apparatus may include a facial mesh tracker to receive a plurality of image frames, detect, through the plurality of image frames, facial action movements of a face of a user, and head pose gestures of a head of the user, and output a plurality of facial motion parameters that depict facial action movements detected, and a plurality of head pose gestures parameters that depict head pose gestures detected, all in real time, for animation and rendering of an avatar. The facial action movements and the head pose gestures may be detected through inter-frame differences for a mouth and an eye of the face, and the head, based on pixel sampling of the image frames.

In embodiments, the facial action movements may include opening or closing of a mouth, and blinking of an eye, and the plurality of facial motion parameters may include parameters that depict the opening or closing of the mouth and blinking of the eye. The head pose gestures may include pitch, yaw, roll of a head, horizontal and vertical movement of a head, and distance change of a head (becoming closer or farther to the camera capturing the image frames), and the plurality of head pose parameters may include parameters that depict the pitch, yaw, roll, horizontal/vertical movement, and distance change of the head.

In embodiments, the apparatus may further include an avatar animation engine coupled with the facial mesh tracker to receive the plurality of facial motion parameters outputted by the facial mesh tracker, and drive an avatar model to animate the avatar, replicating a facial expression of the user on the avatar, through blending of a plurality of pre-defined shapes. Further, the apparatus may include an avatar rendering engine, coupled with the avatar animation engine, to draw the avatar as animated by avatar animation engine.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

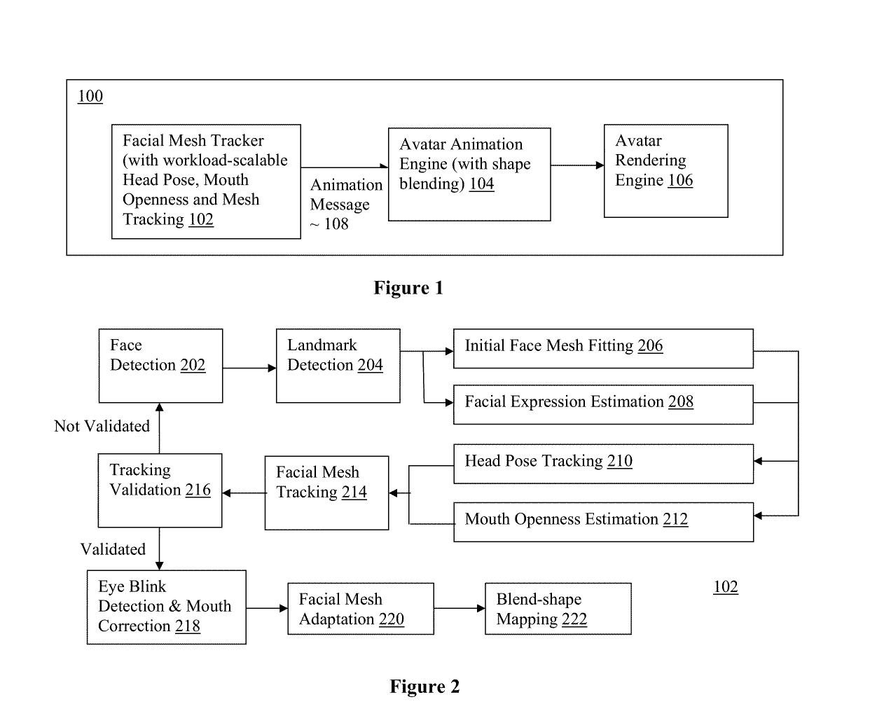

Referring now to FIG. 1, wherein a pocket avatar system, according to the disclosed embodiments, is shown. As illustrated, pocket avatar system 100 may include facial mesh tracker 102, avatar animation engine 104, and avatar rendering engine 106, coupled with each other as shown. Facial mesh tracker 102 may be configured to receive a plurality of image frames, e.g., from an image source, such as a camera (not shown), detect facial action movements of a face of a user and/or head pose gestures of a head of the user, within the plurality of image frames, and output a plurality of facial motion parameters that depict facial action movements detected, e.g., eye and/or mouth movements, and head pose gestures parameters that depict head pose gestures detected, such as head rotation, movement, and/or coming closer or farther from the camera, all in real time. Avatar animation engine 104 may be configured to receive the plurality of facial motion parameters outputted by the facial mesh tracker 102, and drive an avatar model to animate the avatar, replicating a facial expression and/or head movement of the user on the avatar. Avatar rendering engine 106 may be configured to draw the avatar as animated by avatar animation engine 104.

In embodiments, facial mesh tracker 102 may include at least head pose, mouth openness, and mesh tracking function blocks that are sufficiently accurate, yet scalable in their processing power required, making pocket avatar system 100 suitable to be hosted by a wide range of mobile computing devices, such as smartphones and/or computing tablets. Additionally, in embodiments, avatar animation engine 104 may replicate a facial expression of the user on the avatar, through blending of a plurality of pre-defined shapes, further making pocket avatar system 100 suitable to be hosted by a wide range of mobile computing devices.

In embodiments, facial mesh tracker 102 may be configured to generate and output animation messages 108 having the facial motion parameters that depict facial action movements detected and head pose gesture parameters that depict head pose gestures, for avatar animation engine 104. In embodiments, facial mesh tracker 102 and avatar animation engine 104 may be further configured to cooperate to support user interaction driven avatar animation, where a canned expression, e.g., sticking a tongue out, corresponding to a user interaction, e.g., a swipe gesture, may be animated, in lieu of detected facial expression and/or head pose. Similarly, facial mesh tracker 102 may be configured to detect, generate and output animation messages 108 having information about the user interaction, e.g., a start period, a keep period, and an end period, and/or the corresponding canned expression.

In embodiments, facial mesh tracker 102 may be configured to generate a normalized head pose of the user by using a 3D facial action model and a 3D neutral facial shape of the user pre-constructed using a 3D facial shape model. Both, the 3D facial action model and the 3D facial shape model may be pre-constructed through machine learning of a 3D facial database.

While pocket avatar system 100 is designed to be particularly suitable to be operated on a mobile device, such as a smartphone, a phablet, a computing tablet, a laptop computer, or an e-reader, the disclosure is not to be so limited. It is anticipated that pocket avatar system 100 may also be operated on computing devices with more computing power than the typical mobile devices, such as a desktop computer, a game console, a set-top box, or a computer server. The foregoing and other aspects of pocket avatar system 100 will be described in further detail in turn below.

FIG. 2 illustrates a block diagram for the facial mesh tracker of FIG. 1 in further detail, according to the disclosed embodiments. As illustrated, in embodiments, facial mesh tracker 102 may include face detection function block 202, landmark detection function block 204, initial face mesh fitting function block 206, facial expression estimation function block 208, head pose tracking function block 210, mouth openness estimation function block 212, facial mesh tracking function block 214, tracking validation function block 216, eye blink detection and mouth correction function block 218, facial mesh adaptation function block 220 and blend shape mapping function block 222, coupled with each other as shown. Function blocks 202-222 may be implemented in hardware, e.g., ASIC or programmable devices programmed with the appropriate logic, software to be executed by general and/or graphics processors, or a combination of both.

In embodiments, face detection function block 202 may be configured to detect the face through window scan of one or more of the plurality of image frames received. At each window position, modified census transform (MCT) features may be extracted, and a cascade classifier may be applied to look for the face. Landmark detection function block 204 may be configured to detect landmark points on the face, e.g., eye centers, nose-tip, mouth corners, and face contour points. Given a face rectangle, an initial landmark position may be given according to mean face shape. Thereafter, the exact landmark positions may be found iteratively through an explicit shape regression (ESR) method.

In embodiments, initial face mesh fitting function block 206 may be configured to initialize a 3D pose of a face mesh based at least in part on a plurality of landmark points detected on the face. A Candide3 wireframe head model may be used. The rotation angles, translation vector and scaling factor of the head model may be estimated using the POSIT algorithm. Resultantly, the projection of the 3D mesh on the image plane may match with the 2D landmarks. Facial expression estimation function block 208 may be configured to initialize a plurality of facial motion parameters based at least in part on a plurality of landmark points detected on the face. The Candide3 head model may be controlled by facial action parameters (FAU), such as mouth width, mouth height, nose wrinkle, eye opening. These FAU parameters may be estimated through least square fitting.

Head pose tracking function block 210 may be configured to calculate rotation angles of the user's head, including pitch, yaw and/or roll, and translation distance along horizontal, vertical direction, and coming closer or going farther from the camera. The calculation may be based on a subset of sub-sampled pixels of the plurality of image frames, applying dynamic template matching and re-registration. Mouth openness estimation function block 212 may be configured to calculate opening distance of an upper lip and a lower lip of the mouth. The correlation of mouth geometry (opening/closing) and appearance may be trained using a sample database. Further, the mouth opening distance may be estimated based on a subset of sub-sampled pixels of a current image frame of the plurality of image frames, applying FERN regression.

Facial mesh tracking function block 214 may be configured to adjust position, orientation or deformation of a face mesh to maintain continuing coverage of the face and reflection of facial movement by the face mesh, based on a subset of sub-sampled pixels of the plurality of image frames. The adjustment may be performed through image alignment of successive image frames, subject to pre-defined FAU parameters in Candide3 model. The results of head pose tracking function block 210 and mouth openness may serve as soft-constraints to parameter optimization. Tracking validation function block 216 may be configured to monitor face mesh tracking status, to determine whether it is necessary to re-locate the face. Tracking validation function block 216 may apply one or more face region or eye region classifiers to make the determination. If the tracking is running smoothly, operation may continue with next frame tracking, otherwise, operation may return to face detection function block 202, to have the face re-located for the current frame.

Eye blink detection and mouth correction function block 218 may be configured to detect eye blinking status and mouth shape. Eye blinking may be detected through optical flow analysis, whereas mouth shape/movement may be estimated through detection of inter-frame histogram differences for the mouth. As refinement of whole face mesh tracking, eye blink detection and mouth correction function block 216 may yield more accurate eye-blinking estimation, and enhance mouth movement sensitivity. Face mesh adaptation function block 220 may be configured to reconstruct a face mesh according to derived facial action units, and re-sample of a current image frame under the face mesh to set up processing of a next image frame. Shape mapping function block 222 may be configured to convert facial action units into blend-shape coefficients for the animation of the avatar. Since face tracking may use different mesh geometry and animation structure with avatar rendering side, shape mapping function block 220 may also be configured to perform animation coefficient conversion and face model retargeting for avatar animation engine 104. In embodiments, shape mapping function block 220 may output a number of face tracking parameters as the blend shape weights, for avatar animation engine 104. These face tracking parameters may include, but are not limited to “lower lip down” (LLIPD), “both lips widen” (BLIPW), “both lips up” (BLIPU), “nose wrinkle” (NOSEW) and “eyebrow down” (BROWD).

Having head pose tracking function block 210 estimates head pose angle and mouth openness estimation function block 212 estimates mouth opening distance, their results may serve as a soft constraint to the numerical optimization performed by facial mesh tracking function block 214. The arrangement may provide more stable estimation of facial movement parameters, and potentially prevent drifting problems in visual tracking, resulting in less computation requirement, and more suitable for operation on mobile devices, which typically have less computing resources/power than desktop devices or servers.

Additionally, the employment of tracking validation function block 216 to validate the face patch covered the face mesh provides in-time failure recovery in visual tracking, again making pocket avatar system 100 particularly suitable for operation on a wide range of mobile devices. The employment of eye blink detection and mouth correction function block 218, operating on more granular re-sampled pixels around the eyes and mouth areas, after tracking validation, may improve the eye blink detection accuracy and enhances the mouth movement sensitivity.

Further, with head pose tracking function block 210, mouth openness estimation 212 and facial mesh tacking function block 214 operating on subsets of sub-sampled pixels, the workload of these function blocks may be more scalable, as the workload may be substantially proportional to the number of pixels sampled. Accordingly, the workload may be adjusted, in view of the available computing power, by adjusting the density of pixel sampling. In embodiments, similar strategy may be adopted for face detection function block 202, landmark detection 204, tracking validation function bock 216, and eye blink detection and mouth 218. The region of interest may be first resized to a smaller size before the corresponding image analysis is performed. As a result, the workload of these function blocks 202-204 and 216-218 may be made substantially independent of the image frame size, and may be more scalable in view of available computing resource/power, making portable avatar system 100 more suitable for mobile devices.

Referring back to FIG. 1, as described earlier, avatar animation engine 104 may be configured to animate avatar employing shape blending, to speed up its operations. In embodiments, a model with neutral expression and some typical expressions, such as mouth open, mouth smile, brow-up, and brow-down, blink, etc., may be first pre-constructed, prior to facial tracking and animation. The blend shapes may be decided or selected for various tracker 102 capabilities and target mobile device system requirements. During operation, as described earlier facial mesh tracker 202 may output the blend shape weights for avatar animation engine 104.

Upon receiving the blend shape weights (αᵢ) for the various blend shapes, avatar animation engine 104 may generate the expressed facial results with the formula:

$${B}^{*} = {B}_{0} + {\sum }_{i} {α}_{i} \cdot Δ {B}_{i}$$

where
B* is the target expressed facial,
B₀ is the base model with neutral expression, and
ΔBᵢ is i^{th} blend shape that stores the vertex position offset based on base model for specific expression.

Compared with other facial animation techniques, such as motion transferring and mesh deformation, using blend shape for facial animation may have several advantages: 1) Expressions customization: expressions may be customized according to the concept and characteristics of the avatar, when the avatar models are created. The avatar models may be made more funny and attractive to users. 2) Low computation cost: the computation may be configured to be proportional to the model size, and made more suitable for parallel processing. 3) Good scalability: addition of more expressions into the framework may be made easier.

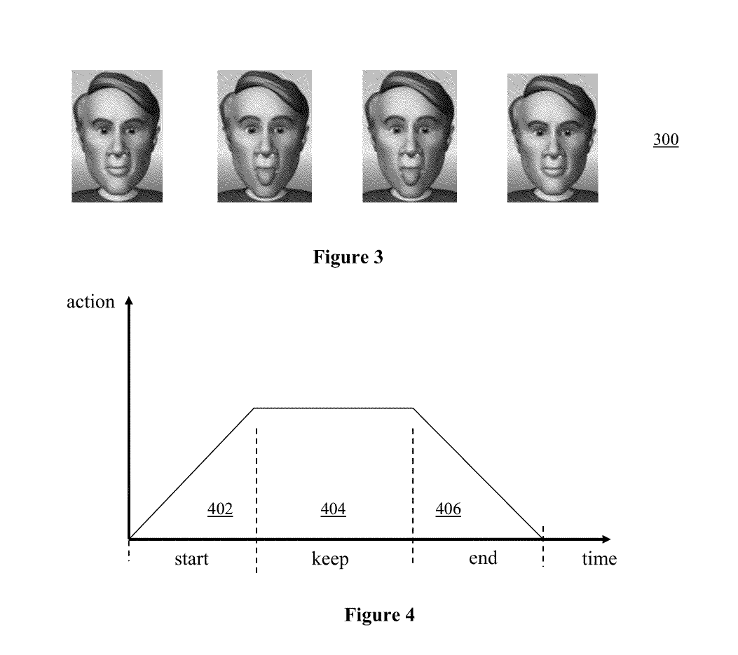

Still referring to FIG. 1, as described earlier, in embodiments, facial mesh tracker 102 may be configured to generate and output animation messages 108 having the facial motion parameters that depict facial action movements detected, for avatar animation engine 104. In embodiments, facial mesh tracker 102 and avatar animation engine 104 may be further configured to cooperate to support user interaction driven avatar animation, where a canned expression, e.g., sticking a tongue out, corresponding to a user interaction, e.g., a swipe gesture, may be animated, in lieu of detected facial expression. See FIG. 3, wherein the example animation of the canned expression 300 of sticking a tongue out, corresponding to a user interaction, is illustrated. Similarly, facial mesh tracker 102 may be configured to detect, generate and output animation messages 108 having information about the user interaction, e.g., a start period 402, a keep period 404, and an end period 406, as illustrated in FIG. 4, and/or the corresponding canned expression.

In embodiments, there may be two types of animation messages 108, facial expression animation messages, and interaction messages. The facial expression messages may be used to support facial expression driven avatar animation, whereas the interaction messages may be used to support interaction event driven avatar animation, e.g., touch events driven avatar animation, for devices with touch sensitive screens. In embodiments, a facial expression message may be 88 bytes in length. The first 12 bytes may be used to specify an avatar type, a version and a message size. The remaining 76 bytes may be used to specify various attributes or characteristics of the facial expressions. For the facial expression data, in embodiments, the first 12 bytes may specify the head pose, the next 36 bytes may specify various pre-defined blend shapes, with the remaining 28 bytes reserved. In embodiments, animation message 108 may be compressed, with the head pose and blend shape data quantized to 16-bit short and 8-bit byte respectively.

In embodiments, the interaction messages may specify the interaction type, and duration information. The interaction type may index to a corresponding canned expression to be animated, e.g., but not limited, tongue-out 300, wink (not shown), kiss (not shown), and so forth. The duration information may specify a start period 402, a keep period 404 and an end period 406. In embodiments, start period 402 may define the number of frames in the starting stage. For example, for the TongueOut example, the avatar will stick out the tongue in this stage. Keep period 404 may define the time to keep the current status, whereas end period 406 may define when the avatar should recover back to neutral expression. In other words, end period 406 may define the recovering time from the interaction expression to the neutral face.

In embodiments, all interaction events have the same priority, and all facial expression events have the same priority, while interaction events have higher priority than the facial expression events. That means: 1) an interaction event cannot interrupt other interaction events. It will take effect only after the end of the current interaction event. During an interaction event, the event queue will not accept another interaction event; 2) an interaction event can interrupt facial expression events anytime. When a new interaction event is detected, the facial mesh tracker 102 will replace the facial expression event with the interaction event at that time frame. After that, the facial expression event will resume to take effect.

As described earlier, in embodiments, avatar animation engine 104 may employ blend shapes. For these embodiments, the expression may be animated for the start, keep and end periods 402-404 as follows:

$${B}_{t} = \{ \begin{matrix}{B}_{0} + \frac{t}{{N}_{z}} Δ B , & if 0 \leq t < {N}_{s} \\ {B}_{0} + Δ B , & if {N}_{s} \leq t < {N}_{s} + {N}_{k} \\ {B}_{0} + \frac{t - {N}_{s} - {N}_{s}}{{N}_{s}} Δ B , & if {N}_{s} + {N}_{k} \leq t < {N}_{s} + {N}_{k} + {N}_{s}\end{matrix}$$

where
Bₜ is the expression at a point in time,
B₀ and AB are as earlier defined,
t is time, and
Nₛ, Nₖ, and Nₑ are the number of frames for the start, keep and end periods.

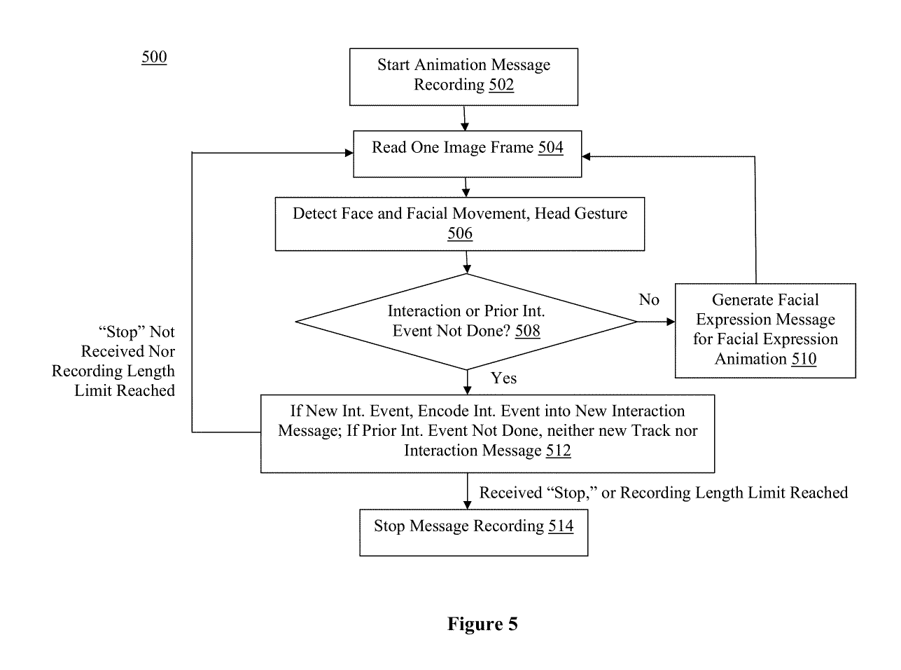

Referring now to FIG. 5, wherein a process for generating facial expression and interaction animation messages, is illustrated, according to the disclosed embodiments.

Process 500 for generating facial expression and interaction animation messages may be performed e.g., by the earlier described facial mesh tracker 102 of FIG. 1. As shown, the process may start at block 502 where recording of animation messages may begin. Message recording may begin in response to e.g., a user providing a start recording instruction, such as a click on a start recording button in a user interface provided by pocket avatar system 100. At block 504, an image frame may be read. At block 506, a face and facial movements within the image frame may be detected.

At block 508, a determination may be made as to whether a new interaction has been detected, or a prior interaction event remains not completed. If no new interaction has been detected, nor any prior interaction event remains in progress, at block 510, a facial expression message with facial movement data may be generated, for facial expression animation. From block 510, process 500 may continue at block 504 as earlier described.

At block 512, if a new interaction has been detected, a new interaction message with the interaction and duration information may be generated, to facilitate animation of the corresponding canned expression. However, if a prior interaction event remains in progress, neither facial expression nor interaction message will be generated, allowing interaction animation of the corresponding canned expression of the prior interaction to continue. From block 512, process 500 may continue at block 504 as earlier described, if neither a stop recording instruction has been received, nor a recording length limit threshold has been reached. On the other hand, if either a stop recording instruction has been received, or a recording length limit threshold has been reached, process 500 may proceed to block 514 and terminates.

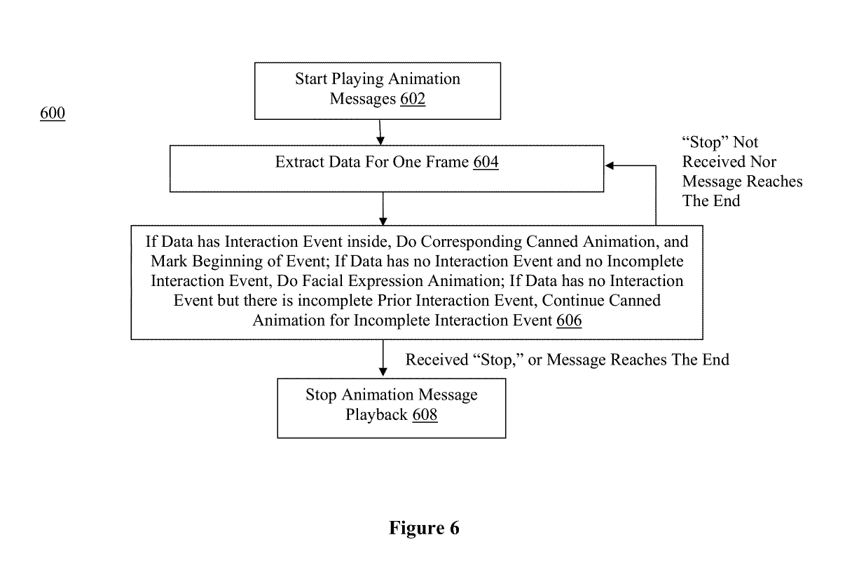

FIG. 6 is a flow diagram illustrating a process for interleaving facial expression and interaction driven animation, according to the disclosed embodiments. Process 600 for interleaving facial expression and interaction driven animation may be performed e.g., by the earlier described avatar animation engine 104 of FIG. 1. As shown, the process may start at block 602 where playing of animation messages may begin. Message playing may begin contemporaneously with recording, in response to e.g., a user providing a start recording/playing instruction, such as a click on a start recording/playing button in a user interface provided by pocket avatar system 100. At block 604, an animation message corresponding to an image frame may be read, and its data extracted.

At block 606, if the extracted data has interaction event inside, animation of the index canned expression is performed. Further, a marking of the beginning of a new interaction event may be made. However, if the extracted data has no interaction event inside, and currently there is no incomplete animation of any canned expression for a prior interaction event, animation of facial expression, in accordance with the facial expression data in the animation message is performed. On the other hand, if the extracted data has no interaction event inside, but currently there is incomplete animation of a canned expression for a prior interaction event, then animation of the canned expression corresponding to the prior interaction event continues.

From block 606, process 600 may continue at block 604 as earlier described, if neither a stop recording/playing instruction has been received, nor end of messages has been reached. On the other hand, if either a stop recording/playing instruction has been received, or end of messages has been reached, process 600 may proceed to block 608 and terminates.

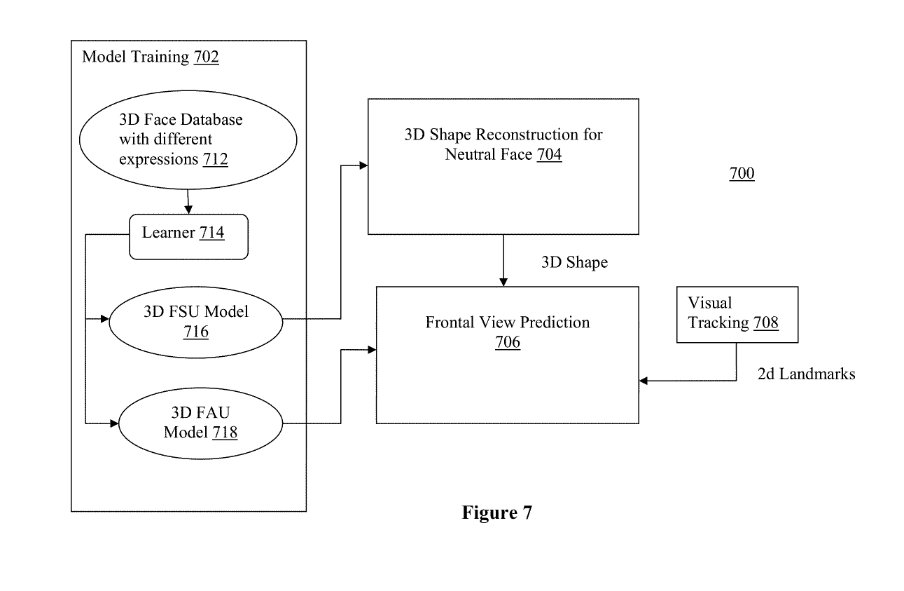

Referring now to FIG. 7, wherein a flow diagram illustrating a process for estimating head pose, is illustrated, according to the disclosed embodiments. As shown, process 700 for estimating head pose may include model training operations 702, 3D shape reconstruction for neutral face operations 704, frontal view prediction operations 706, and visual tracking operations 708. Model training operations 702 may be performed offline, prior to operation of tracking, animation and rendering by portable avatar system 100, whereas 3D shape reconstruction for neutral face operations 704, frontal view prediction operations 706, and visual tracking operations 708 may be performed by the earlier described facial mesh tracker 102.

As shown, model training operations 702 may include using a learner 714 to learn a 3D Facial Shape Units Model (FSU) 716 and a 3D Facial Action Units (FAU) 718 from a 3D face database having a substantial collection of different facial expressions, e.g., hundreds of identities, each having several typical expressions, and the key landmark points are provided. The 3D FSU model may describe a space with variant face shapes, whereas the 3D FAU model may describe local motion of facial components (facial expression). More specifically, in embodiments, a principal component analysis (PCA) may be first performed on all 3D shapes with neutral expression. After that, mean shapes for each expression may be computed. The difference between the means shapes with expression, and the mean shape of neutral may be taken as the FAU model. In embodiments, each FAU may be designed for just one component's motion in one dimension. Examples of components may include eye, eyebrow, nose, mouth, and so forth. Thus, the FAUs are independent, and can be composed together to obtain a complex facial expression, e.g., a surprise expression may include mouth-open and brow-up FAUs.

In embodiments, 3D shape reconstruction for neutral face operations 704 may be performed during registration of a user, wherein a number of neutral faces may be collected, and employed to construct a 3D neutral face. More specifically, in embodiments, 3D FSUs describing face shape variance may be used to reconstruct the 3D face shape through minimization of the difference between 2D projection and a neutral face registered B₀, by solving the following optimization problem:

$${min}_{α} ‖ {B}_{0} - {T}_{2 d} ( {P}_{0} + α P ) ‖$$

where
P₀ is the mean shape of 3D FSU,
P is an eigen vector of 3D FSU,
α is a linear combination coefficient, and
T_{2d} is a projection from 3D space to 2D image space.

A 3D shape thus may be constructed by computing:

B_{3d}=P₀+αP

In embodiments, frontal view prediction operations 706 may be performed to reconstruct a 3D shape S_{3d}, using the 3D face shape of the user constructed during registration and the 3D FAU model, by minimizing the difference between 2D projection from 3D shape and the 2D image landmarks S₀ provided by visual tracking operations 708, as follows:

S_{3d}=bR(B_{3d}+γQ)+t

where
b, R and t are rigid transformation parameters (scale, rotation, and translation,
Q is the 3D FAU model, and
γ is the 3D FAU model's coefficients.

Similar to 3D shape reconstruction for neutral face operations 704, the solution may be obtained by solving the optimization problem of:

$${min}_{γ , B , b , t} ‖ {S}_{0} - {T}_{2 d} [ bB ( {B}_{3 d} + γ Q ) + t ] ‖$$

In embodiments, the optimization problem may be solved by updating the value of the rigid transformation parameters and 3D FAU coefficients separately, and iteratively. In other words, dividing the optimization problem into two sub-problems:

$${min}_{γ} ‖ {S}_{0} - {T}_{2 d} [ bR ( {B}_{3 d} + γ Q ) + t ] ‖ , \\ given b , R and t . \\ {min}_{R , b , t} ‖ {S}_{0} - {T}_{2 d} [ bR ( {B}_{3 d} + γ Q ) + t ] ‖ , \\ given γ .$$

Thereafter, the landmark in the front view without 3D rigid transformation may be obtained with the optimization of:
where S_{2d} is the 2D projection of 3D shape with FAUs for the user with a specific face shape.

The head pose tracking may complement the facial mesh tracking. In combination, the two tracking may validate each other, and improve overall tacking robustness. Experiments have shown the disclosed portable avatar system 100 to be very efficient for mobile devices, capable of processing 70 frames per second on a Samsung Galaxy S3 phone and 110 frames per second on Apple iPhone5.

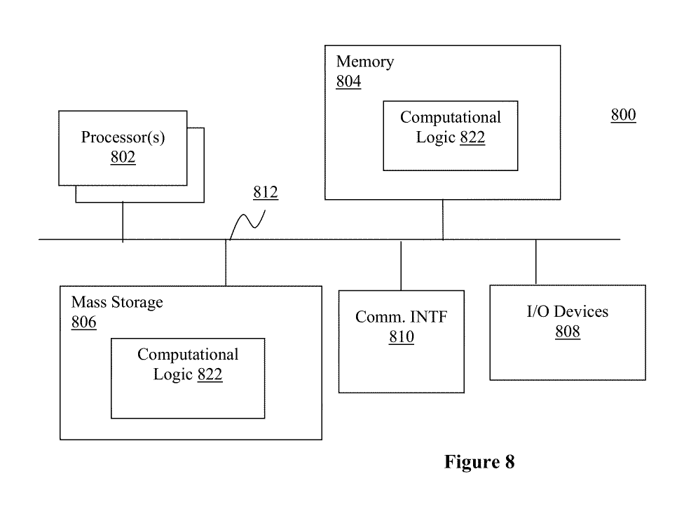

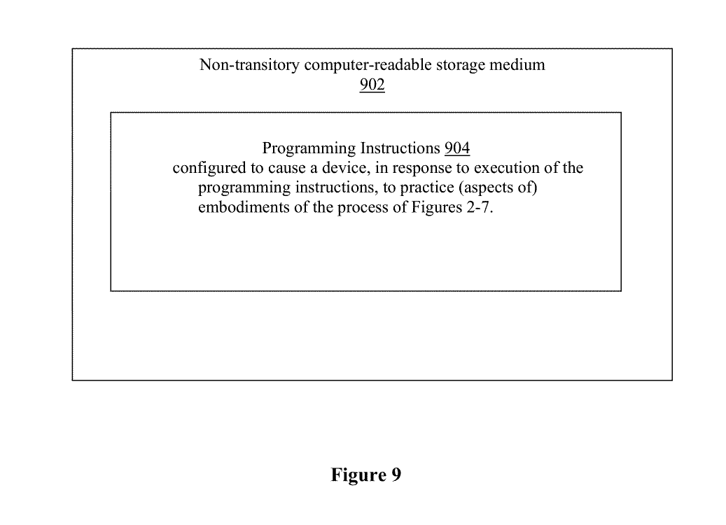

FIG. 8 illustrates an example computer system that may be suitable for use as a client device or a server to practice selected aspects of the present disclosure. As shown, computer 800 may include one or more processors or processor cores 802, and system memory 804. For the purpose of this application, including the claims, the terms “processor” and “processor cores” may be considered synonymous, unless the context clearly requires otherwise. Additionally, computer 800 may include mass storage devices 806 (such as diskette, hard drive, compact disc read only memory (CD-ROM) and so forth), input/output devices 808 (such as display, keyboard, cursor control and so forth) and communication interfaces 810 (such as network interface cards, modems and so forth). The elements may be coupled to each other via system bus 812, which may represent one or more buses. In the case of multiple buses, they may be bridged by one or more bus bridges (not shown).

Each of these elements may perform its conventional functions known in the art. In particular, system memory 804 and mass storage devices 806 may be employed to store a working copy and a permanent copy of the programming instructions implementing the operations associated with facial mesh tracker 102, avatar animation engine 104 and avatar rendering engine 106, earlier described, collectively referred to as computational logic 822. The various elements may be implemented by assembler instructions supported by processor(s) 802 or high-level languages, such as, for example, C, that can be compiled into such instructions.

The number, capability and/or capacity of these elements 810-812 may vary, depending on whether computer 800 is used as a client device or a server. When use as client device, the capability and/or capacity of these elements 810-812 may vary, depending on whether the client device is a stationary or mobile device, like a smartphone, computing tablet, ultrabook or laptop. Otherwise, the constitutions of elements 810-812 are known, and accordingly will not be further described.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 9 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 902 may include a number of programming instructions 904. Programming instructions 904 may be configured to enable a device, e.g., computer 800, in response to execution of the programming instructions, to perform, e.g., various operations associated with facial mesh tracker 102, avatar animation engine 104 and avatar rendering engine 106. In alternate embodiments, programming instructions 904 may be disposed on multiple computer-readable non-transitory storage media 902 instead. In alternate embodiments, programming instructions 904 may be disposed on computer-readable transitory storage media 902, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Referring back to FIG. 8, for one embodiment, at least one of processors 802 may be packaged together with memory having computational logic 822 (in lieu of storing on memory 804 and storage 806). For one embodiment, at least one of processors 802 may be packaged together with memory having computational logic 822 to form a System in Package (SiP). For one embodiment, at least one of processors 802 may be integrated on the same die with memory having computational logic 822. For one embodiment, at least one of processors 802 may be packaged together with memory having computational logic 822 to form a System on Chip (SoC). For at least one embodiment, the SoC may be utilized in, e.g., but not limited to, a smartphone or computing tablet.

Thus various example embodiments of the present disclosure have been described including, but are not limited to:

Example 1 may be an apparatus for rendering avatar. The apparatus may comprise one or more processors; and a facial mesh tracker. The facial mesh tracker may be operated by the one or more processors, to receive a plurality of image frames, detect, through the plurality of image frame, facial action movements of a face of a user and head pose gestures of a head of the user, and output a plurality of facial motion parameters that depict facial action movements detected, a plurality of head gesture parameters that depict head pose gestures detected, all in real time, for animation and rendering of an avatar. Further, detection of facial action movements, and head pose gestures may include detection of inter-frame differences for a mouth and an eye on the face, and the head, based on pixel sampling of the image frames.

Example 2 may be example 1, wherein the facial action movements may include opening or closing of the mouth, and blinking of the eye, and the plurality of facial motion parameters may include first one or more facial motion parameters that depict the opening or closing of the mouth and second one or more facial motion parameters that depict blinking of the eye.

Example 3 may be example 1 or 2, wherein the plurality of image frames may be captured by a camera, and the head pose gestures may include head rotation, movement along horizontal and vertical directions, and the head comes closer or goes farther from the camera; and wherein the plurality of head pose gesture parameters may include head pose gesture parameters that depict head rotation, head movement along horizontal and vertical directions, and head comes closer or goes farther from the camera.

Example 4 may be any one of examples 1-3, wherein the facial mesh tracker may include a face detection function block to detect the face through window scan of one or more of the plurality of image frames; wherein window scan may comprise extraction of modified census transform features and application of a cascade classifier at each window position.

Example 5 may be any one of examples 1-4, wherein the facial mesh tracker may include a landmark detection function block to detect landmark points on the face; wherein detection of landmark points may comprise assignment of an initial landmark position in a face rectangle according to mean face shape, and iteratively assign exact landmark positions through explicit shape regression.

Example 6 may be any one of examples 1-5, wherein the facial mesh tracker may include an initial face mesh fitting function block to initialize a 3D pose of a face mesh based at least in part on a plurality of landmark points detected on the face, employing a Candide3 wireframe head model.

Example 7 may be any one of examples 1-6, wherein the facial mesh tracker may include a facial expression estimation function block to initialize a plurality of facial motion parameters based at least in part on a plurality of landmark points detected on the face, through least square fitting.

Example 8 may be any one of examples 1-7, wherein the facial mesh tracker may include a head pose tracking function block to calculate rotation angles of the user's head, based on a subset of sub-sampled pixels of the plurality of image frames, applying dynamic template matching and re-registration.

Example 9 may be any one of examples 1-8, wherein the facial mesh tracker may include a mouth openness estimation function block to calculate opening distance of an upper lip and a lower lip of the mouth, based on a subset of sub-sampled pixels of the plurality of image frames, applying FERN regression.

Example 10 may be any one of examples 1-9, wherein the facial mesh tracking function block may adjust position, orientation or deformation of a face mesh to maintain continuing coverage of the face and reflection of facial movement by the face mesh, based on a subset of sub-sampled pixels of the plurality of image frames, and image alignment of successive image frames.

Example 11 may be any one of examples 1-10, wherein the facial mesh tracker may include a tracking validation function block to monitor face mesh tracking status, applying one or more face region or eye region classifiers, to determine whether it is necessary to relocate the face.

Example 12 may be any one of examples 1-11, wherein the facial mesh tracker may include a mouth shape correction function block to correct mouth shape, through detection of inter-frame histogram differences for the mouth.

Example 13 may be any one of examples 1-12, wherein the facial mesh tracker may include an eye blinking detection function block to estimate eye blinking, through optical flow analysis.

Example 14 may be any one of examples 1-13, wherein the facial mesh tracker may include a face mesh adaptation function block to reconstruct a face mesh according to derived facial action units, and re-sample a current image frame under the face mesh to set up processing of a next image frame.

Example 15 may be any one of examples 1-14, wherein the facial mesh tracker may include blend-shape mapping function block to convert facial action units into blend-shape coefficients for the animation of the avatar.

Example 16 may be any one of examples 1-15, further comprising an avatar animation engine coupled with the facial mesh tracker to receive the plurality of facial motion parameters outputted by the facial mesh tracker, and drive an avatar model to animate the avatar, replicating a facial expression of the user on the avatar, through blending of a plurality of pre-defined shapes.

Example 17 may be any one of examples 1-16, further comprising an avatar rendering engine coupled with the avatar animation engine to draw the avatar as animated by avatar animation engine.

Example 18 may be any one of examples 1-17, wherein the apparatus is a selected one of a smartphone, a phablet, a computing tablet, a laptop computer, a e-reader, a desktop computer, a game console, a set-top box, or a computer server.

Example 19 may be a method for rendering an avatar. The method may comprise receiving, by a facial mesh tracker operating on a computing device, a plurality of image frames; detecting, by the facial mesh tracker, through the plurality of image frames, facial action movements of a face of a user, and head pose gestures of a head of the user; and outputting, by the facial mesh tracker, a plurality of facial motion parameters that depict facial action movements detected, and a plurality of head pose gesture parameters that depict head pose gestures detected. Additionally, receiving, detecting and outputting may all be performed in real time, for animation and rendering of an avatar. Further, detecting facial action movements and head pose gestures may include detecting inter-frame differences for a mouth and an eye of the face, and the head, based on pixel sampling of the image frames.

Example 20 may be example 19, wherein the facial action movements may include opening or closing of the mouth, and blinking of the eye, and the plurality of facial motion parameters include first one or more facial motion parameters that depict the opening or closing of the mouth and second one or more facial motion parameters that depict blinking of the eye.

Example 21 may be example 19 or 20, wherein the plurality of image frames may be captured by a camera, and the head pose gestures may include head rotation, movement along horizontal and vertical directions, and the head comes closer or goes farther from the camera; and wherein the plurality of head pose gesture parameters may include head pose gesture parameters that depict head rotation, head movement along horizontal and vertical directions, and head comes closer or goes farther from the camera.

Example 22 may be any one of examples 19-21, wherein detecting may comprise detecting the face through window scanning of one or more of the plurality of image frames; wherein window scanning comprises extracting modified census transform features and applying a cascade classifier at each window position.

Example 23 may be any one of examples 19-22, wherein detecting may comprise detecting landmark points on the face; wherein detecting landmark points may comprise assigning an initial landmark position in a face rectangle according to mean face shape, and iteratively assigning exact landmark positions through explicit shape regression.

Example 24 may be any one of examples 19-23, wherein detecting may comprise initializing a 3D pose of a face mesh based at least in part on a plurality of landmark points detected on the face, employing a Candide3 wireframe head model.

Example 25 may be any one of examples 19-24, wherein detecting may include initializing a plurality of facial motion parameters based at least in part on a plurality of landmark points detected on the face, through least square fitting.

Example 26 may be any one of examples 19-25, wherein detecting may comprise calculating rotation angles of the user's head, based on a subset of sub-sampled pixels of the plurality of image frames, applying dynamic template matching and re-registration.

Example 27 may be any one of examples 19-26, wherein detecting may include calculating opening distance of an upper lip and a lower lip of the mouth, based on a subset of sub-sampled pixels of the plurality of image frames, applying FERN regression.

Example 28 may be any one of examples 19-27, wherein detecting may comprise adjusting position, orientation or deformation of a face mesh to maintain continuing coverage of the face and reflection of facial movement by the face mesh, based on a subset of sub-sampled pixels of the plurality of image frames, and aligning successive image frames.

Example 29 may be any one of examples 19-28, wherein detecting may comprise monitoring face mesh tracking status, applying one or more face region or eye region classifiers, to determine whether it is necessary to re-locate the face.

Example 30 may be any one of examples 19-29, wherein detecting may include correcting mouth shape, through detection of inter-frame histogram differences for the mouth.

Example 31 may be any one of examples 19-30, wherein detecting may comprise estimating eye blinking, through optical flow analysis.

Example 32 may be any one of examples 19-31, wherein detecting may comprise reconstructing a face mesh according to derived facial action units, and re-sampling a current image frame under the face mesh to set up processing of a next image frame.

Example 33 may be any one of examples 19-32, wherein detecting may comprise converting facial action units into blend-shape coefficients for the animation of the avatar.

Example 34 may be any one of examples 19-33, further comprising: receiving, by an avatar animation engine operating on the computing device, the plurality of facial motion parameters outputted; and driving, by the avatar animation engine, an avatar model to animate the avatar, replicating a facial expression of the user on the avatar, through shape blending.

Example 35 may be any one of examples 19-34, further comprising drawing, by an avatar rendering engine operating on the computing device, the avatar as animated by avatar animation engine.

Example 36 may be one or more computer-readable storage medium comprising a plurality of instructions to cause a computing device, in response to execution of the instructions by the computing device, to perform any one of the method examples of 19-35.

Example 37 may be an apparatus for rendering avatar. The apparatus may comprise: facial mesh tracking means for receiving a plurality of image frames, detecting, through the plurality of image frames, facial action movements of a face of a user, and head pose gestures of the user, and outputting a plurality of facial motion parameters that depict facial action movements detected, and a plurality of head pose gestures parameters, all in real time, for animation and rendering of an avatar. Further, detecting facial action movements and head pose gestures may include detecting inter-frame differences for a mouth and an eye of the face, and the head, based on pixel sampling of the image frames.

Example 38 may be example 37 further comprising avatar animation means for receiving the plurality of facial motion parameters, and driving an avatar model to animate the avatar, replicating a facial expression of the user on the avatar, through shape blending.

Example 39 may be example 38 further comprising avatar rendering means for drawing the avatar as animated by avatar animation engine.

Example 40 may be an apparatus for rendering an avatar. The apparatus may comprise: one or more processors, a facial mesh tracker and an animation engine. The facial mesh tracker may be operated by the one or more processors, to receive a plurality of image frames, first detect facial action movements of a face within the plurality of image frames, first generate first one or more animation messages recording the facial action movements, second detect one or more user interactions with the apparatus during receipt of the plurality of image frames and first detection of facial action movements of a face within the plurality of image frames, and second generate second one or more animation messages recording the one or more user interactions detected, all in real time. Further, the animation engine may be coupled with the facial mesh tracker, to drive an avatar model to animate an avatar, interleaving replication of the recorded facial action movements on the avatar based on the first one or more animation messages, with animation of one or more canned facial expressions corresponding to the one or more recorded user interactions based on the second one or more animation messages.

Example 41 may be example 40, wherein each of the first one or more animation messages may comprise a first plurality of data bytes to specify an avatar type, a second plurality of data bytes to specify head pose parameters, and a third plurality of data bytes to specify a plurality of pre-defined shapes to be blended to animate the facial expression.

Example 42 may be example 40 or 41, wherein each of the second one or more animation messages may comprise a first plurality of data bits to specify a user interaction, and a second plurality of data bits to specify a duration for animating the canned facial expression corresponding to the user interaction specified.

Example 43 may be any one of examples 40-42, wherein the duration may comprise a start period, a keep period and an end period for the animation.

Example 44 may be example 43, wherein the avatar animation engine may animate the corresponding canned facial expression blending one or more pre-defined shapes into a neutral face based at least in part on the start, keep and end periods.

Example 45 may be any one of examples 40-42, wherein second detect may comprise second detect of whether a new user interaction occurred and whether a prior detected user interaction has completed, during first detection of facial action movements of a face within an image frame.

Example 46 may be any one of examples 40-42, wherein the facial mesh tracker to start performance of the receipt, the first detect, the first generate, the second detect and the second generate, in response to a start instruction, and to stop performance of the receipt, the first detect, the first generate, the second detect and the second generate, in response to a stop instruction, or the number or a total size of the first and second animation messages reach a threshold.

Example 47 may be any one of examples 40-42, wherein the avatar animation engine is to determine whether data within an animation message comprises recording of occurrence of a new user interaction or incompletion of a prior detected user interaction, during recovery of facial action movement data from an animation message for an image frame.

Example 48 may be any one of examples 40-42, wherein the avatar animation engine is to start performance of the animation, in response to a start instruction, and to stop performance of the animation, in response to a stop instruction, or completion of processing of all first and second animation messages.

Example 49 may be a method for rendering an avatar. The method may comprise: receiving, by a facial mesh tracker operating on a computing device, a plurality of image frames; first detecting, by the facial mesh tracker, facial action movements of a face within the plurality of image frames; first generating, by the facial mesh tracker, first one or more animation messages recording the facial action movements; second detecting, by the facial mesh tracker, one or more user interactions with the computing device during receipt of the plurality of image frames and first detecting of facial action movements of a face within the plurality of image frames; and second generating second one or more animation messages recording the one or more user interactions detected. Further, the may include driving, by an avatar animation engine, an avatar model to animate an avatar, interleaving replication of the recorded facial action movements on the avatar based on the first one or more animation messages, with animation of one or more canned facial expressions corresponding to the one or more recorded user interactions based on the second one or more animation messages. Additionally, the receiving, the first detecting, the first generating, the second detecting, the second generating, and the driving, may all be performed in real time.

Example 50 may be example 49, wherein each of the first one or more animation messages may comprise a first plurality of data bytes to specify an avatar type, a second plurality of data bytes to specify head pose parameters, and a third plurality of data bytes to specify a plurality of pre-defined shapes to be blended to animate the facial expression.

Example 51 may be example 49 or 50, wherein each of the second one or more animation messages comprises a first plurality of data bits to specify a user interaction, and a second plurality of data bits to specify a duration for animating the canned facial expression corresponding to the user interaction specified.

Example 52 may be example 51, wherein the duration may comprise a start period, a keep period and an end period for the animation.

Example 53 may be example 52, wherein animating the corresponding canned facial expression comprises blending one or more pre-defined shapes into a neutral face based at least in part on the start, keep and end periods.

Example 54 may be any one of examples 49-53, wherein second detecting may comprise second detecting whether a new user interaction occurred and whether a prior detected user interaction has completed, during first detecting of facial action movements of a face within an image frame.

Example 55 may be any one of examples 49-54, wherein performance of receiving, first detecting, first generating, second detecting and second generating, is in response to a start instruction, and performance to stop, in response to a stop instruction, or the number or a total size of the first and second animation messages reaching a threshold.

Example 56 may be any one of examples 49-55, wherein driving may comprise determining whether data within an animation message comprises recording of occurrence of a new user interaction or incompletion of a prior detected user interaction, during recovery of facial action movement data from an animation message for an image frame.

Example 57 may be any one of methods of examples 49-56, wherein performance of driving, is in response to a start instruction, and performance to stop, in response to a stop instruction, or completion of processing of all first and second animation messages.

Example 58 may be one or more computer-readable storage medium comprising a plurality of instructions to cause a computing device, in response to execution of the instructions by the computing device, to perform any one of the example methods of 49-57.

Example 59 may be an apparatus for rendering an avatar. The apparatus may comprise: facial mesh tracking means for receiving a plurality of image frames, first detecting facial action movements of a face within the plurality of image frames, first generating first one or more animation messages recording the facial action movements, second detecting one or more user interactions with the apparatus during receiving of the plurality of image frames and first detecting of facial action movements of a face within the plurality of image frames, and second generating second one or more animation messages recording the one or more user interactions detected, all in real time; and avatar animation means for driving an avatar model to animate an avatar, interleaving replication of the recorded facial action movements on the avatar based on the first one or more animation messages, with animation of one or more canned facial expressions corresponding to the one or more recorded user interactions based on the second one or more animation messages.

Example 60 may be example 59, wherein each of the first one or more animation messages may comprise a first plurality of data bytes to specify an avatar type, a second plurality of data bytes to specify head pose parameters, and a third plurality of data bytes to specify a plurality of pre-defined shapes to be blended to animate the facial expression.

Example 60 may be example 59 or 60, wherein each of the second one or more animation messages may comprise a first plurality of data bits to specify a user interaction, and a second plurality of data bits to specify a duration for animating the canned facial expression corresponding to the user interaction specified.

Example 62 may be example 61, wherein the duration may comprise a start period, a keep period and an end period for the animation.

Example 63 may be example 62, wherein the avatar animation means may comprise means for animating the corresponding canned facial expression, by blending one or more pre-defined shapes into a neutral face based at least in part on the start, keep and end periods.

Example 64 may be an apparatus for rendering avatar. The apparatus may comprise: one or more processors; and a facial mesh tracker. The facial mesh tracker may be operated by the one or more processors, to receive a plurality of image frames, detect facial action movements of a face within the plurality of image frames, and output a plurality of facial motion parameters that depict facial action movements detected, all in real time, for animation and rendering of an avatar. Additionally, the face may be a face of a user, and the facial mesh tracker may detect facial action movements of the face through a normalized head pose of the user. Further, the facial mesh tracker may generate the normalized head pose of the user by using a 3D facial action model and a 3D neutral facial shape of the user pre-constructed using a 3D facial shape model.

Example 65 may be example 64, wherein the facial mesh tracker may generate the normalized head pose of the user through minimization of differences between 2D projection of the 3D neutral facial shape and detected 2D image landmarks.

Example 66 may be example 64 or 65, wherein the 3D facial action model is pre-developed offline through machine learning of a 3D facial database.

Example 67 may be any one of examples 64-66, wherein 3D neutral facial shape of the user may be pre-constructed using the 3D facial shape model, during registration of the user.

Example 68 may be any one of examples 64-67, wherein the 3D facial shape model may be pre-developed offline through machine learning of a 3D facial database.

Example 69 may be a method for rendering avatar. The method may comprise: receiving, by a facial mesh tracker operating on a computing device, a plurality of image frames; detecting, by the facial mesh tracker, facial action movements of a face within the plurality of image frames; and outputting, by the facial mesh tracker, a plurality of facial motion parameters that depict facial action movements detected, for animation and rendering of an avatar. Further, the face may be a face of a user, and detecting facial action movements of the face may be through a normalized head pose of the user, and may comprise generating the normalized head pose of the user by using a 3D facial action model and a 3D neutral facial shape of the user pre-constructed using a 3D facial shape model.

Example 70 may be example 69, wherein generating the normalized head pose of the user may comprise minimizing differences between 2D projection of the 3D neutral facial shape and detected 2D image landmarks.

Example 71 may be example 69 or 70, further comprising pre-developing offline the 3D facial action model through machine learning of a 3D facial database.

Example 72 may be example 69 or 71, further comprising pre-constructing the 3D neutral facial shape of the user using the 3D facial shape model, during registration of the user.

Example 73 may be example 69 or 72, further comprising pre-developing the 3D facial shape model offline through machine learning of a 3D facial database.

Example 74 may be one or more computer-readable storage medium comprising a plurality of instructions to cause a computing device, in response to execution of the instructions by the computing device, to perform any one of the methods of examples 69-73.

Example 75 may be an apparatus for rendering avatar. The apparatus may comprise: facial mesh tracking means for receiving a plurality of image frames, detecting facial action movements of a face within the plurality of image frames, and outputting a plurality of facial motion parameters that depict facial action movements detected, all in real time, for animation and rendering of an avatar. Further, the face may be a face of a user, and facial mesh tracker means may comprise means for detecting facial action movements of the face through a normalized head pose of the user, and means for generating the normalized head pose of the user by using a 3D facial action model and a 3D neutral facial shape of the user pre-constructed using a 3D facial shape model.

Example 76 may example 75, wherein means for generating the normalized head pose of the user may comprise means for minimizing differences between 2D projection of the 3D neutral facial shape and detected 2D image landmarks.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

1. An apparatus for rendering avatar, comprising:
one or more processors; and
a facial mesh tracker, to be operated by the one or more processors, to receive a plurality of image frames, detect, through the plurality of image frame, facial action movements of a face of a user and head pose gestures of a head of the user, and output a plurality of facial motion parameters that depict facial action movements detected, a plurality of head gesture parameters that depict head pose gestures detected, all in real time, for animation and rendering of an avatar;
wherein detection of facial action movements, and head pose gestures includes detection of inter-frame differences for a mouth and an eye on the face, and the head, based on pixel sampling of the image frames.

2. The apparatus of claim 1, wherein the facial action movements include opening or closing of the mouth, and blinking of the eye, and the plurality of facial motion parameters include first one or more facial motion parameters that depict the opening or closing of the mouth and second one or more facial motion parameters that depict blinking of the eye.

3. The apparatus of claim 1, wherein the plurality of image frames are captured by a camera, and the head pose gestures include head rotation, movement along horizontal and vertical directions, and the head comes closer or goes farther from the camera; and wherein the plurality of head pose gesture parameters include head pose gesture parameters that depict head rotation, head movement along horizontal and vertical directions, and head comes closer or goes farther from the camera.

4. The apparatus of claim 1, wherein the facial mesh tracker includes a face detection function block to detect the face through window scan of one or more of the plurality of image frames; wherein window scan comprises extraction of modified census transform features and application of a cascade classifier at each window position.

5. The apparatus of claim 1, wherein the facial mesh tracker includes a landmark detection function block to detect landmark points on the face; wherein detection of landmark points comprises assignment of an initial landmark position in a face rectangle according to mean face shape, and iteratively assign exact landmark positions through explicit shape regression.

6. The apparatus of claim 1, wherein the facial mesh tracker includes an initial face mesh fitting function block to initialize a 3D pose of a face mesh based at least in part on a plurality of landmark points detected on the face, employing a Candide3 wireframe head model.

7. The apparatus of claim 1, wherein the facial mesh tracker includes a facial expression estimation function block to initialize a plurality of facial motion parameters based at least in part on a plurality of landmark points detected on the face, through least square fitting.

8. The apparatus of claim 1, wherein the facial mesh tracker includes a head pose tracking function block to calculate rotation angles of the user's head, based on a subset of sub-sampled pixels of the plurality of image frames, applying dynamic template matching and re-registration.

9. The apparatus of claim 1, wherein the facial mesh tracker includes a mouth openness estimation function block to calculate opening distance of an upper lip and a lower lip of the mouth, based on a subset of sub-sampled pixels of the plurality of image frames, applying FERN regression.

10. The apparatus of claim 1, wherein the facial mesh tracking function block is to adjust position, orientation or deformation of a face mesh to maintain continuing coverage of the face and reflection of facial movement by the face mesh, based on a subset of sub-sampled pixels of the plurality of image frames, and image alignment of successive image frames.

11. The apparatus of claim 1, wherein the facial mesh tracker includes a tracking validation function block to monitor face mesh tracking status, applying one or more face region or eye region classifiers, to determine whether it is necessary to relocate the face.

12. The apparatus of claim 1, wherein the facial mesh tracker includes a mouth shape correction function block to correct mouth shape, through detection of inter-frame histogram differences for the mouth.

13. The apparatus of claim 1, wherein the facial mesh tracker includes an eye blinking detection function block to estimate eye blinking, through optical flow analysis.

14. The apparatus of claim 1, wherein the facial mesh tracker includes a face mesh adaptation function block to reconstruct a face mesh according to derived facial action units, and re-sample a current image frame under the face mesh to set up processing of a next image frame.

15. The apparatus of claim 1, wherein the facial mesh tracker includes blend-shape mapping function block to convert facial action units into blend-shape coefficients for the animation of the avatar.

16. The apparatus of claim 1 further comprising:
an avatar animation engine coupled with the facial mesh tracker to receive the plurality of facial motion parameters outputted by the facial mesh tracker, and drive an avatar model to animate the avatar, replicating a facial expression of the user on the avatar, through blending of a plurality of pre-defined shapes; and
an avatar rendering engine coupled with the avatar animation engine to draw the avatar as animated by avatar animation engine.

17. An apparatus for rendering an avatar, comprising:
one or more processors; and
a facial mesh tracker, to be operated by the one or more processors, to receive a plurality of image frames, first detect facial action movements of a face within the plurality of image frames, first generate first one or more animation messages recording the facial action movements, second detect one or more user interactions with the apparatus during receipt of the plurality of image frames and first detection of facial action movements of a face within the plurality of image frames, and second generate second one or more animation messages recording the one or more user interactions detected, all in real time; and
an animation engine, coupled with the facial mesh tracker, to drive an avatar model to animate an avatar, interleaving replication of the recorded facial action movements on the avatar based on the first one or more animation messages, with animation of one or more canned facial expressions corresponding to the one or more recorded user interactions based on the second one or more animation messages.

18. The apparatus of claim 17, wherein each of the first one or more animation messages comprises a first plurality of data bytes to specify an avatar type, a second plurality of data bytes to specify head pose parameters, and a third plurality of data bytes to specify a plurality of pre-defined shapes to be blended to animate the facial expression.

19. The apparatus of claim 17, wherein each of the second one or more animation messages comprises a first plurality of data bits to specify a user interaction, and a second plurality of data bits to specify a duration for animating the canned facial expression corresponding to the user interaction specified.

20. The apparatus of claim 19, wherein the duration comprises a start period, a keep period and an end period for the animation; and wherein the avatar animation engine to animate the corresponding canned facial expression blending one or more pre-defined shapes into a neutral face based at least in part on the start, keep and end periods.

21. The apparatus of claim 17, wherein second detect comprises second detect of whether a new user interaction occurred and whether a prior detected user interaction has completed, during first detection of facial action movements of a face within an image frame; and wherein the avatar animation engine to determine whether data within an animation message comprises recording of occurrence of a new user interaction or incompletion of a prior detected user interaction, during recovery of facial action movement data from an animation message for an image frame.

22. A method for rendering avatar, comprising:
receiving, by a facial mesh tracker operating on a computing device, a plurality of image frames;
detecting, by the facial mesh tracker, facial action movements of a face within the plurality of image frames; and
outputting, by the facial mesh tracker, a plurality of facial motion parameters that depict facial action movements detected, for animation and rendering of an avatar;
wherein the face is a face of a user, and detecting facial action movements of the face is through a normalized head pose of the user, comprises generating the normalized head pose of the user by using a 3D facial action model and a 3D neutral facial shape of the user pre-constructed using a 3D facial shape model.

23. The method of claim 22, wherein generating the normalized head pose of the user comprises minimizing differences between 2D projection of the 3D neutral facial shape and detected 2D image landmarks.

24. The method of claim 22, further comprises pre-developing offline the 3D facial action model and the 3D facial shape model, through machine learning of a 3D facial database.

25. The method of claim 22, further comprising pre-constructing the 3D neutral facial shape of the user using the 3D facial shape model, during registration of the user.
